(19) United States
(12) Patent Application Publication
(10) Pub. No.: US 2006/0030486 A1
(43) Pub. Date: Feb. 9, 2006

(54) Crystallization inhibitor for plant-protective formulations

(75) Inventors: Gerd Roland Meyer, Frankfurt am Main (DE); Ralf Zerrer, Karlstein (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/242,220

(22) Filed: Oct. 3, 2005

Related U.S. Application Data
(63) Continuation of application No. 10/500,028, filed on Feb. 14, 2005.

(30) Foreign Application Priority Data
Dec. 22, 2001 (DE) 10163902.3

(51) Int. Cl. A01N 63/00

(52) U.S. Cl. 504/117; 526/287; 526/288; 526/320; 526/329.6; 526/333; 504/129; 504/361; 504/363; 524/833

(57) ABSTRACT

The invention relates to the use of polymers based on acrylamidopropylmethylenesulfonic acid (AMPS) and macromonomers as crystallization inhibitor for plant protection formulations. The polymers inhibit crystallization of the pesticidal active substances (herbicides, insecticides, fungicides, acaricides, bactericides, molluscicides, nematicides and rodenticides) present in the plant protection formulations. The use in the case of emulsifiable concentrates (EC) and suspension concentrates (SC) is particularly advantageous.

### CROSS-REFERENCE TO RELATED APPLICATIONS

This application is a continuation of copending application Ser. No. 10/500,028, having a 371(c) date of Feb. 14, 2005, which is hereby incorporated by reference.

The present invention relates to the use of water-soluble copolymers based on acrylamidopropylmethylenesulfonic acid (AMPS) or its salts and macromonomers as crystallization inhibitor in plant protection formulations.

Pesticidal active substances with predominantly hydrophobic groups and low polarity are compounds with very little solubility in water. The formulation possibilities are essentially restricted to emulsifiable concentrates (EC) and suspension concentrates (SC). These are diluted with water to the desired spray strength by the user and are applied.

A fine constant particle size of the solid active substances is important for the necessary storage stability of the concentrated aqueous suspension. Crystallization results in the formation of larger particles and accordingly in sedimentation, which hinders the required uniform dilutability of the concentrate and possibly also blocks the filter and spray system. A rather different difficulty resulting from crystallization occurs with emulsifiable concentrates. These normally anhydrous concentrates are likewise diluted with water to the desired spray strength by the user. Due to solubility in water of the organic solvent used, considerable crystallization of the active substances in the spray emulsion can occur. This results in a loss in effectiveness of the active substances, the danger of the filter system and spray system becoming blocked, and a high purification outlay.

It has now been found, surprisingly, that polymers based on acrylamidopropylmethylenesulfonic acid (AMPS) and macromonomers are highly suitable as crystallization inhibitor in plant protection compositions. In this connection, the polymers inhibit crystallization of the pesticidal active substances (herbicides, insecticides, fungicides, acaricides, bactericides, molluscicides, nematicides and rodenticides) present in the plant protection formulations.

The present invention accordingly relates to the use of polymers, which can be prepared by radical copolymerization of
A) acrylamidopropylmethylenesulfonic acid (AMPS) and/or its salts;
B) one or more macromonomers comprising
i) a terminal group which is capable of polymerizing and which is at least partially soluble in the reaction medium,
ii) a hydrophobic part which is hydrogen or a saturated or unsaturated, linear or branched, aliphatic, cycloaliphatic or aromatic C₁-C₁₀₀)-hydrocarbon residue, and
iii) optionally a hydrophilic part based on polyalkylene oxides; and
C) optionally one or more additional at least mono- or polyolefinically unsaturated oxygen-, nitrogen-, sulfur-, phosphorus-, chlorine- and/or fluorine-comprising comonomers,
as crystallization inhibitor in plant protection formulations.

The macromonomers B) preferably comprise a hydrophilic part based on polyalkoxides, preferably polyethylene oxides and/or polypropylene oxides.

Suitable salts of acrylamidopropylmethylenesulfonic acid (AMPS) are preferably the lithium, sodium, potassium, magnesium, calcium, ammonium, monoalkylammonium, dialkylammonium, trialkylammonium or tetraalkylammonium salts, the alkyl substituents of the ammonium ions being, independently of one another, (C₁-C₂₂)-alkyl residues which can carry 0 to 3 hydroxyalkyl groups, the alkyl chain length of which can vary within the range of from C₂ to C₁₀. Likewise suitable are mono- to triethoxylated ammonium compounds with a variable degree of ethoxylation. Salts which are particularly preferred are the sodium and ammonium salts. The degree of neutralization of the acrylamidopropyl-methylenesulfonic acid (AMPS) is preferably 70 to 100 mol %.

The comonomer A) is preferably the sodium salt and/or ammonium salt of acrylamidopropylmethylenesulfonic acid (AMPS).

The macromonomers B) are preferably those of the formula (1)
R¹—Y—(R²—O)ₓ(R⁴—O)—R³ (1)
in which
R¹ is a vinyl, allyl, acryloyl [i.e. CH₂═CH—CO—], methacryloyl [i.e.
CH₂═C(CH₃)—CO—], senecioyl or crotonyl residue;
R² and R⁴ are, independently of one another, (C₂-C₄)-alkylene;
x and z are, independently of one another, an integer between 0 and 500, preferably with x+z greater than or equal to 1;
Y is O, S, PH or NH, preferably 0; and
R³ is hydrogen or a saturated or unsaturated, linear or branched, aliphatic, cycloaliphatic or aromatic (C₁-C₁₀₀)-hydro-carbon residue, preferably (C₁-C₃₀)- hydrocarbon residue.

R¹ is particularly preferably an acryloyl or methacryloyl residue.

R² and R⁴ are particularly preferably a C₂- or C₃-alkylene residue.
x and z are particularly preferably, independently of one another, a number between 0 and 50, preferably with x+z greater than or equal to 1. Particularly preferably, 5≦x+z≦50 applies.

R³ is particularly preferably an aliphatic (C₄-C₂₂)-alkyl or -alkenyl residue, preferably (C₁₀-C₂₂)-alkyl or -alkenyl residue;
a phenyl residue;
a (C₁-C₂₂)-alkylphenyl residue, preferably (C₁-C₉)-alkylphenyl residue, particularly preferably (C₁-C₄)-alkylphenyl residue, especially preferably sec-butyl- or n-butylalkylphenyl residue;
a poly((C₁-C₂₂)-alkyl)phenyl residue, preferably poly((C₁-C₉)-alkyl)phenyl residue, particularly preferably poly((C₁-C₄)-alkyl)phenyl residue, especially preferably poly(sec-butyl)phenyl residue, very particularly preferably tris(sec-butyl)phenyl residue or tris(n-butyl)phenyl residue; or
a polystyrylphenyl residue [i.e. poly(phenylethyl)phenyl residue], particularly preferably tristyrylphenyl residue [i.e. tris(phenylethyl)phenyl residue].

Particular preference is given, as R³ residues, to 2,4,6-tris(1-phenylethyl)-phenyl residues and 2,4,6-tris(sec-butyl)phenyl residues.

The macromonomers B) are preferably prepared by reaction of reactive derivatives of unsaturated carboxylic acids, preferably of methacrylic acid or acrylic acid, with the corresponding, optionally alkoxylated, alkyl or aryl residues comprising hydroxyl groups. The ring-opening addition to the respective carboxylic acid glycidyl esters is also possible.

In a preferred embodiment, the polymers additionally comprise other olefinically unsaturated oxygen-, nitrogen-, sulfur-, phosphorus-, chlorine- and/or fluorine-comprising comonomers C).

Preference is given, as comonomers C), to olefinically unsaturated acids or their salts, preferably with mono- and divalent counterions, particularly preferably styrenesulfonic acid, vinylsulfonic acid, vinylphosphonic acid, allylsulfonic acid, methallylsulfonic acid, acrylic acid, methacrylic acid and/or maleic acid or maleic anhydride, fumaric acid, crotonic acid, itaconic acid or senecioic acid or their salts. Preferred counterions are Li⁺, Na⁺, K.⁺, Mg²⁺, Ca²⁺, Al³⁺, NH₄⁺, monoalkylammonium, dialkylammonium, dialkylammonium, trialkylammonium and tetraalkylammonium ions, in which the substituents of the amines are, independently of one another, (C₁-C₂₂)-alkyl residues which can carry 0 to 3 hydroxyalkyl groups, the alkyl chain length of which can vary within the range C₂ to C₁₀. In addition, mono- to triethoxylated ammonium compounds with a variable degree of ethoxylation, and corresponding acid anhydrides (also mixed), can also be used. The degree of neutralization of the optional olefinically unsaturated acids C) can be 0 to 100 mol %, preferably 70 and 100 mol %.

Also suitable as comonomers C) are esters of unsaturated carboxylic acids, preferably acrylic acid, methacrylic acid, styrenesulfonic acid, maleic acid, fumaric acid, crotonic acid and senecioic acid, with aliphatic, aromatic or cycloaliphatic alcohols with a carbon number of 1 to 30.

Suitable comonomers C) are likewise acyclic and cyclic N-vinylamides (N-vinyllactam) with a ring size of 4 to 9 atoms, preferably N-vinylformamide (NVF); N-vinylmethylformamide; N-vinylmethylacetamide (VIMA); N-vinylacetamide; N-vinylpyrrolidone (NVP); N-vinylcaprolactam; amides of acrylic acid and of methacrylic acid, particularly preferably acrylamide, N,N-dimethylacrylamide, N,N-diethylacrylamide, N,N-diisopropylacrylamide; alkoxylated acrylamides and methacrylamides, preferably hydroxymethylmethacrylamide, hydroxyethylmethacrylamide and hydroxypropylmethacrylamide.

Likewise suitable are succinic acid mono[2-(methacryloyloxy)ethyl ester]; N,N-dimethylamino methacrylate; diethylaminomethyl methacrylate; acryl- and methacrylamidoglycolic acid; [2-(methacryloyloxy)ethyl]trimeth-ylammonium chloride (MAPTAC) and [2-(acryloyloxy)ethyl]trimethylammonium chloride (APTAC); 2-vinylpyridine; 4-vinylpyridine; vinyl acetate; methacrylic acid glycidyl ester; acrylonitrile; vinyl chloride; vinylidene chloride; tetrafluoroethylene; diallyldimethyldimethylammonium chloride (DADMAC); stearyl acrylate; lauryl methacrylate; and/or tetrafluoroethylene.

Also suitable are methylenebisacrylamide and methylenebismethacrylamide; esters of unsaturated mono- and polycarboxylic acids with polyols, e.g. diacrylates or triacrylates, such as butanediol diacrylate or dimethacrylate, ethylene glycol diacrylate or dimethacrylate, and trimethylolpropane triacrylate; allyl compounds, e.g. allyl (meth)acrylate, triallyl cyanurate, maleic acid diallyl ester, polyallyl esters, tetraallyloxyethane, triallylamine, tetraallylethylenediamine, allyl esters of phosphoric acid and/or vinylphosphonic acid derivatives.

Particular preference is given for the use to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from methacrylic acid or acrylic acid, preferably methacrylic acid, and compounds of the formula (2)
   HO—(CH₂—CH₂—O)ₓ—R³ (2)
in which x is a number between 0 and 50, preferably 1 and 50, particularly preferably 5 and 30, and R³ is a (C₁₀-C₂₂)-alkyl residue; and
C) optionally one or more comonomers chosen from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

Particularly suitable as macromonomers B) are esters formed from acrylic acid or methacrylic acid and alkyl ethoxylates chosen from the group consisting of
(C₁₀-C₁₈)-fatty alcohol polyglycol ethers with 8 EO units (Genapol® C-080);
C₁₁-oxo alcohol polyglycol ethers with 8 EO units (Genapol® UD-080);
(C₁₂-C₄)-fatty alcohol polyglycol ethers with 7 EO units (Genapol® LA-070);
(C₁₂-C₁₄)-fatty alcohol polyglycol ethers with 11 EO units (Genapol® LA-110);
(C₁₆-C₁₈)-fatty alcohol polyglycol ethers with 8 EO units (Genapol® T-080);
(C₁₆-C₁₈)-fatty alcohol polyglycol ethers with 15 EO units (Genapo® T-150);
(C₁₆-C₁₈)-fatty alcohol polyglycol ethers with 11 EO units (Genapol® T-110);
(C₁₆-C₁₈)-fatty alcohol polyglycol ethers with 20 EO units (Genapol® T-200);
(C₁₆-C₁₈)-fatty alcohol polyglycol ethers with 25 EO units (Genapol® T-250);
(C₁₈-C₂₂)-fatty alcohol polyglycol ethers with 25 EO units;
iso(C₁₆-C₁₈)-fatty alcohol polyglycol ethers with 25 EO units; and
C₂₂-fatty alcohol polyglycol ethers with 25 EO units (Mergital® B 25).

In this connection, the EO units are ethylene oxide units. The Genapol® grades are products from Clariant and Mergital® B25 is a product from Cognis.

Particular preference is likewise given for the use to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from acrylic acid or methacrylic acid, preferably methacrylic acid, and compounds of the formula (3)
   HO—(CH₂—CH₂—O)ₓ—R³ (3)
in which
x is a number between 0 and 50, preferably 1 and 50, particularly preferably 5 and 30, and
R³ is a poly((C₁-C₂₂)-alkyl)phenyl residue, preferably tris(sec-butyl)phenyl residue or tris(n-butyl)phenyl residue, particularly preferably 2,4,6-tris(sec-butyl)phenyl residue, or a tris(styryl)phenyl residue, preferably 2,4,6-tris(1-phenylethyl)phenyl residue; and
C) optionally one or more comonomers chosen from acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

The proportion by weight of the comonomers C) and macromonomers B) in the polymer can vary between 0.1 and 99.9% by weight.

In a preferred embodiment, the polymers are highly hydrophobically modified, i.e. that carries the proportion of macromonomers B) is 50.1 to 99.9% by weight, preferably 70 to 95% by weight, particularly preferably 80 to 94% by weight.

In another preferred embodiment, the polymers are poorly hydrophobically modified, i.e. the proportion of macromonomers B) is 0.1 to 50% by weight, preferably 5 to 25% by weight, particularly preferably 6 to 20% by weight.

The monomer distribution of the comonomers A), B) and C) in the polymers can be alternating, random, gradient or block (also multiblock).

The number-average molecular weight of the polymers is preferably 1000 to 20 000 000 g/mol, preferably 20 000 to 5 000 000 g/mol, particularly preferably 50 000 to 1 500 000 g/mol.

In a preferred embodiment, the polymers are crosslinked, i.e. at least one crosslinking agent with at least two double bonds is copolymerized in the polymer.

Preferred crosslinking agents are methylenebisacrylamide and methylenebismethacrylamide; esters of unsaturated mono- or polycarboxylic acids with polyols, preferably diacrylates and triacrylates, e.g. butanediol diacrylate or dimethacrylate, ethylene glycol diacrylate or dimethacrylate, and trimethylolpropane triacrylate, allyl compounds, preferably allyl (meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

The polymers are preferably prepared by radical copolymerization, e.g. precipitation polymerization, emulsion polymerization, solution polymerization or suspension polymerization.

Particularly suitable are polymers prepared by precipitation polymerization, preferably in tert-butanol. By the use of precipitation polymerization in tert-butanol, a specific particle size distribution of the polymers can be achieved in comparison with other solvents. The size distribution of the polymer particles can be determined, e.g., by laser diffraction or sieve analysis. The following particle size distribution is representative of a convenient size distribution, the particle size distribution being, as was determined by sieve analysis: 60.2% less than 423 micrometers, 52.0% less than 212 micrometers, 26.6% less than 106 micrometers, 2.6% less than 45 micrometers and 26.6% greater than 850 micrometers.

The polymerization reaction can be carried out in the temperature range between 0 and 150° C., preferably between 10 and 100° C., both at standard pressure and under increased or reduced pressure. As usual, the polymerization can also be carried out in a protective gas atmosphere, preferably under nitrogen.

The polymerization can be initiated by the use of high-energy electromagnetic radiation or the usual chemical polymerization initiators, e.g. organic peroxides, such as benzoyl peroxide, tert-butyl hydroperoxide, methyl ethyl ketone peroxide or cumene hydroperoxide, azo compounds, such as, e.g., azobisisobutyronitrile or azobisdimethylvaleronitrile, and inorganic peroxy compounds, such as, e.g., (NH₄)₂S₂O₈, K₂S₂O₈ or H₂O₂, optionally in combination with reducing agents, such as, e.g., sodium hydrogensulfite and iron(II) sulfate, or redox systems comprising, as reducing component, an aliphatic or aromatic sulfonic acid, such as, e.g., benzenesulfonic acid, toluenesulfonic acid or derivatives of these acids, such as, e.g., Mannich adducts from sulfinic acid, aldehydes and amino compounds.

The polymers are preferably used, when used as crystallization inhibitor, in amounts, based on the finished plant protection formulations, of 0.01 to 10% by weight, particularly preferably 0.1 to 7% by weight, particularly preferably 0.5 to 5% by weight.

In the use according to the invention of the polymers, the plant protection formulations can comprise one or more pesticidal active substances from the group consisting of herbicides, insecticides, fungicides, acaricides, bactericides, molluscicides, nematicides and rodenticides.

The use of the polymers as crystallization inhibitors is then particularly advantageous if the active substances, because of their low polarity or high hydrophobicity, are sparingly soluble in water and are particularly strongly inclined to crystallize. Mention may in particular be made here of the active substances from the category of the sulfonates, for example ethofumesate and benfuresate; anilides, for example propanil; phenylurea derivatives, e.g. monuron or diuron; azoles, e.g. amitrole; triazines, e.g. simazine and atrazine; propionic acid derivatives, e.g. dalapon; carbamates; pyrazolinates; tebucanozole; hexaconazole; phenmedipham; desmedipham; linuron; and trifluralin.

The plant protection formulations can comprise a vast number of different compositions.

Preference is given to emulsifiable concentrates (EC), oil-in-water emulsions (EW), water-in-oil emulsions, suspension concentrates (SC), suspoemulsions (SE), suspensions, microemulsions (ME), dispersions and compositions which can be obtained from the abovementioned compositions by diluting with water and/or solvents, preferably water.

It has been shown that the use according to the invention is particularly advantageous with emulsifiable concentrates (EC) and suspension concentrates (SC).

Emulsifiable concentrates (EC) can be prepared in a simple way by metering the active substance(s), the polymer or polymers and the remaining formulation components into the initial solvent or solvents and dissolving with stirring.

When applying the emulsifiable concentrates (EC), the volumes required each time are measured out, stirred into water and sprayed over the field in the form of their dilute emulsions.

The plant protection formulations can, in addition to the pesticidal active substances and the polymers, comprise additional additives and auxiliaries, for example emulsifiers, dispersants, solvents, thickeners, antifreeze agents, evaporation retardants, preservatives, fragrances, colorants, antigelling agents, wetting agents, protective colloids, dispersants, antifoaming agents and/or neutralizing agents.

Nonionic, amphoteric and anionic surfactants are suitable as emulsifiers and dispersants.

Preferred nonionic emulsifiers or dispersants are addition products of 2 to 80 mol of ethylene oxide and/or up to 5 mol of propylene oxide with linear fatty alcohols with 8 to 22 carbon atoms, with fatty acids with 12 to 22 carbon atoms and with mono-, di- and/or trialkylphenols with 8 to 15 carbon atoms in the alkyl group; (C₂-C₁₈)-fatty acid mono- and diesters of addition products of 5 to 50 mol of ethylene oxide with glycerol; glycerol mono- and diesters and sorbitan/sorbitol mono- and diesters of saturated and unsaturated fatty acids with 6 to 22 carbon atoms and their ethylene oxide addition products. Preference is given to alkylaryl ethoxylates (Arkopale®, Clariant GmbH), nonylphenol ethoxylates (Synperonic® NP-4, Uniquema), alkanoyl ethoxylates (Genapol®, Clariant GmbH) and polyethylene oxide/polypropylene oxide block copolymers.

Preference is given, as ampholytic emulsifiers, to disodium N-lauryl-.beta.-imidodipropionate and lecithin.

Preference is given, as anionic surfactants, to alkyl sulfates, preferably with (C₁₀-C₂₄)-alkyl components or (C₁₀-C₂₄)-hydroxyalkyl components, e.g. alkyl glycerol sulfates, fatty alcohol ether sulfates, glycerol ether sulfates, hydroxy-mixed ether sulfates, fatty acid amide (ether) sulfates or oleyl glycerol sulfates, and alkylaryl sulfates, e.g. alkylphenol ether sulfates; alkyl sulfonates, preferably with (C₁₀-C₂₄)-alkyl components or (C₁₀-C₂₄)-hydroxyalkyl components; alkyl ether sulfonates; glycerol ether sulfonates and alkylbenzene sulfonates.

Lignosulfite waste liquors and ethylcellulose are particularly suitable as dispersants.

Suitable solvents are preferably aliphatic and aromatic hydrocarbons, for example mineral oils, paraffin hydrocarbons, alkylbenzenes, for example toluene or xylene, naphthalene derivatives, in particular 1-methylnaphthalene or 2-methylnaphthalene, (C₆-C₆)-aromatic hydrocarbon mixtures, for example the Solvesso series (Esso) with the Solvesso® 100 (b.p. 162-177° C.), Solvesso® 150 (b.p. 187-207° C.) and Solvesso® 200 (b.p. 219-282° C.) variants, (C₆-C₂₀)- aliphatic hydrocarbons which can be linear or cyclic, for example the Shellsol series, T and K variants, or BP n-paraffin hydrocarbons, likewise halogenated hydrocarbons, for example tetrachloromethane, chloroform, chlorobenzene, chlorotoluene, methylene chloride or dichloroethane, esters, for example triacetin (glyceryl triacetate), butyrolactone, propylene carbonate, triethyl citrate and phthalic acid (C₁-C₂₂)-alkyl esters, in particular phthalic acid (C₄-C₈)-alkyl esters, esters of polyalcohols, ethers, such as diethyl ether, tetrahydrofuran, dioxane, alkylene monoalkyl ethers and dialkyl ethers, such as, e.g., propylene glycol monomethyl ether, propylene glycol monoethyl ether, ethylene glycol monomethyl ether, ethylene glycol monoethyl ether, diglyme and tetraglyme, amides, such as dimethylformamide, dimethylacetamide, di(n-butyl)formamide, caprylic/capric acid dimethylamide and N-alkyl-pyrrolidone, ketones, such as acetone, cyclohexanone, isophorone, acetophenone or methyl ethyl ketone, sulfoxides and sulfones, such as dimethyl sulfoxide and sulfolane, polyglycols, and animal, vegetable and mineral oils.

A multitude of different systems for adjusting the rheological properties of aqueous or solvent-comprising emulsions or suspensions are given in the technical literature. Known examples are cellulose ethers and other cellulose derivatives (e.g. carboxymethylcellulose or hydroxyethylcellulose), gelatin, starch and starch derivatives, sodium alginates, fatty acid polyethylene glycol esters, agar, gum tragacanth or dextrins. Different materials can be used as synthetic polymers, such as, e.g., polyvinyl alcohols, polyacrylamides, polyvinylamides, polysulfonic acids, polyacrylic acid, polyacrylates, polyvinylpyrrolidone, poly(vinyl methyl ether), polyethylene oxides, copolymers of maleic anhydride and vinyl methyl ether, and various blends and copolymers of the above mentioned compounds, including their various salts and esters. These polymers can either be crosslinked or noncrosslinked.

Suitable preservatives are, for example, preventol and proxel and suitable antifoaming agents are, for example, silane derivatives, such as polydimethylsiloxanes, and magnesium stearate or perfluorinated phosphonic or phosphine derivatives.

All conventional materials which can be used as antifreeze agents can be employed for this purpose. Mention may be made, by way of examples, of urea, glycerol and propylene glycol.

All conventional acids and their salts are suitable as buffers. Mention may preferably be made of phosphate buffers, carbonate buffers or citrate buffers.

The plant protection formulations preferably have a pH ranging from 2 to 12, particularly preferably 3 to 8.

The plant protection compositions stabilized in an inhibitory manner use according to the invention of the polymers as crystallization inhibitor are outstandingly stable on storage chemically, physically and with regard to performance.

The following examples serve to clarify the invention without, however, limiting it thereto.

### EXAMPLES

### Example 1

Polymer 1

500 g of toluene were introduced into a 1 l Quickfit flask equipped with a stirrer, an internal thermometer, gas inlet pipes for nitrogen and ammonia gas, and a reflux condenser. In addition, 3.0 g of 2-acrylamido-2-methylpropanesulfonic acid (AMPS) were introduced and were neutralized with the equivalent amount of ammonia. Subsequently, 60.0 g of stearyl acrylate and 30.0 g of isopropanol were added. The contents of the flask are rendered inert with nitrogen while stirring and are heated to 70° C. using a heating bath. After reaching the temperature, 3.0 g of AIBN were added as initiator and the mixture was heated to 80° C. with further flushing with nitrogen. The mixture was stirred at reflux at the stated temperature for 4 h. After the reaction was complete, the product was transferred to a rotary evaporator and the solvent was removed by vacuum distillation at approximately 50° C.

### Example 2

Polymer 2

Analogous procedure as in example 1; in addition, 1.0 g of trimethylolpropane triacrylate (TMPTA) were added for crosslinking.

### Example 3

Polymer 3

Analogous procedure as in example 1; in place of stearyl acrylate, however, 28.0 g of an ester of acrylic acid and a (C₁₂-C₁₄)-fat-ty acid polyglycol ether with 7 EO units were used.

### Example 4

### Use Example

Preparation of a suspension concentrate (SC), which has been stabilized with regard to crystallization, formed from 1 43.60 g atrazine (99%) 40.30 g demineralized water 2.10 g Dispersant LFS® 1.00 g polymer 1 from example 11.50 g Defoamer SE 57® 7.20 g Keizan S® (2% aqueous solution) 4.30 g ethylene glycol

The SC was prepared in a way known to a person skilled in the art. On storing the formulation at room temperature and 54° C., no crystallization whatsoever of the active substance and accordingly no associated sedimentation whatsoever occurred even after a fairly long time, which was not the case in a corresponding formulation without polymer 1.

### Example 5

### Use Example

Preparation of an emulsifiable concentrate (EC) formed from 2 42.00 g dimethoate 45.00 g cyclohexanone 6.00 g Emulsogen EL 360® 6.00 g xylene 1.00 g polymer 2 from example 2

The EC was prepared in a way known to a person skilled in the art. On diluting the EC with water, crystallization of the active substance did not occur even at storage temperatures of 10° C. over a time of several days, crystallization occuring within 30 min in the preparation of the abovementioned EC without use of polymer 2.

### Example 6

### Use Example

Preparation of an emulsifiable concentrate (EC) formed from 3 42.00 g dimethoate 45.00 g cyclohexanone 6.00 g Emulsogen EL 360® 6.00 g xylene 1.00 g polymer 3 from example 3

The EC was prepared in a way known to a person skilled in the art. On diluting the EC with water, crystallization of the active substance did not occur even at storage temperatures of 10° C. over a time of several days, crystallization occuring within 30 min in the preparation of the abovementioned EC without use of polymer 2.

We claim:

1. A method for inhibiting crystallization in a plant protection formulation, said method comprising adding to the plant protection formulation a crystallization inhibitor, wherein said plant protection formulation comprises at least one pesticidal active substance and wherein the crystallization inhibitor is prepared by radical copolymerization of
A) acrylamidopropylmethylenesulfonic acid (AMPS) and/or its salts;
B) one or more macromonomer of the formula (1)
R¹—Y—(R²—O)ₓ(R⁴—O)_{z}—R³ (1)
wherein R¹ is an acryloyl or methacryloyl residue;
R² and R⁴ is, independently of one another, C₂-alkylene or C₃-alkylene;
x and z is, independently of one another, an integer between 0 and 50 wherein x+z is greater than or equal to 1;
R³ is a (C₄-C₂₂)-alkyl or a (C₄-C₂₂)-alkenyl residue; and
D) optionally one or more additional at least mono- or polyolefinically unsaturated oxygen-, nitrogen-, sulfur-, phosphorus-, chlorine- and/or fluorine-comprising comonomers.

2. The plant protection formulation as claimed in claim 1, wherein the comonomer A) is the sodium salt and/or ammonium salt of acrylamidopropylmethylenesulfonic acid (AMPS).

3. The plant protection formulation as claimed in claim 1, wherein the crystallization inhibitor is prepared by radical copolymerization of
A) a compound selected from the group consisting of acrylamidopropylmethylenesulfonic acid (AMPS), the sodium salt of acrylamidopropylmethylenesulfonic acid (AMPS), the ammonium salt of acrylamidopropylmethylenesulfonic acid, and mixtures thereof;
B) one or more macromonomer selected from the group consisting of esters formed from methacrylic acid or acrylic acid, and a compound of the formula (2)
HO—(CH₂—CH₂——O)ₓ—R³ (2)
wherein x is a number between 0 and 50, and
R³ is a (C₁₀-C₂₂)-alkyl residue or mixtures thereof; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

4. The method of claim 1, wherein the one or more macromonomer B) is at least one ester formed from acrylic acid or methacrylic acid and an alkyl ethoxylate selected from the group consisting of
(C₁₀-C₁₈)-fatty alcohol polyglycol ethers with 8 EO units,
C₁₁-oxo alcohol polyglycol ethers with 8 EO units,
(C₁₂-C₁₄)-fatty alcohol polyglycol ethers with 7 EO units,
(C₁₂-C₁₄)-fatty alcohol polyglycol ethers with 11 EO units,
(C₁₆-C₁₈)-fatty alcohol polyglycol ethers with 8 EO units,
(C₁₆-C₁₈)-fatty alcohol polyglycol ethers with 15 EO units,
(C₁₆-C₁₈)-fatty alcohol polyglycol ethers with 11 EO units,
(C₁₆-C₁₈)-fatty alcohol polyglycol ethers with 20 EO units,
(C₁₆-C₁₈)-fatty alcohol polyglycol ethers with 25 EO units,
(C₁₈-C₂₂)-fatty alcohol polyglycol ethers with 25 EO units,
iso(C₁₆-C₁₈)-fatty alcohol polyglycol ethers with 25 EO units,
C₂₂-fatty alcohol polyglycol ethers with 25 EO units, and mixtures thereof.

5. The method of claim 1, wherein the proportion of macromonomer B) in the crystallization inhibitor is from 50.1 to 99.9% by weight.

6. The method of claim 1, wherein the proportion of macromonomer B) in the crystallization inhibitor is from 0.1 to 50% by weight.

7. The method of claim 1, wherein the number-average molecular weight of the crystallization inhibitor is from 1000 to 20 000 000 g/mol.

8. The method of claim 1, wherein the crystallization inhibitor is crosslinked.

9. The method of claim 1, wherein the radical copolymerization is a precipitation polymerization reaction.

10. The method of claim 1, wherein the crystallization inhibitor is present from 0.01 to 10% by weight, based on the plant protection formulation.

11. The method of claim 1, wherein the at least one pesticidal active substance is selected from the group consisting of herbicides, insecticides, fungicides, acaricides, bactericides, molluscicides, nematicides and rodenticides.

12. The method of claim 1, wherein the at least one pesticidal active substance is selected from the group consisting of sulfonates, anilides, phenylurea derivatives, azoles, triazines, propionic acid derivatives, carbamates, pyrazolinates, tebuconazole, hexaconazole, phenmedipham, desmedipham, linuron, trifluralin, and mixtures thereof.

13. The method of claim 1, wherein the plant protection formulation is in a form selected from the group consisting of emulsifiable concentrates (EC), oil-in-water emulsions (EW), water-in-oil emulsions, suspension concentrates (SC), suspoemulsions (SE), suspensions, microemulsions (ME) and dispersions.

14. The method of claim 1, wherein the plant protection formulation is an emulsifiable concentrate (EC) or a suspension concentrate (SC).

15. The method of claim 1, wherein the plant protection formulation is obtained by diluting a composition selected from the group consisting of emulsifiable concentrates (EC), oil-in-water emulsions (EW), water-in-oil emulsions, suspension concentrates (SC), suspoemulsions (SE), suspensions, microemulsions (ME) and dispersions with water and/or solvents.

16. The method of claim 1, wherein the plant protection formulation is obtained by diluting a composition selected from the group consisting of emulsifiable concentrates (EC) and suspension concentrates (SC) with water and/or solvents.

17. The method of claim 1, wherein Y is oxygen.

18. The method of claim 3, wherein x is between 1 and 50.

19. The method of claim 3, wherein x is between 5 and 30.

20. The method of claim 3, wherein the comonomer A) is the ammonium salt of acrylamidopropylmethylenesulfonic acid.

21. The method of claim 3, wherein the one or more macromonomer B) in the crystallization inhibitor is an ester formed from methacrylic acid.

22. The method of claim 1, wherein the proportion of macromonomer B) in the crystallization inhibitors is from 70 to 95% by weight.

23. The method of claim 1, wherein the proportion of macromonomer B) in the crystallization inhibitors is from 80 to 94% by weight.

24. The method of claim 1, wherein the proportion of macomonomer B) in the crystallization inhibitor is from 5 to 25% by weight.

25. The method of claim 1, wherein the proportion of macomonomer B) in the crystallization inhibitor is from 6 to 20% by weight.

26. The method of claim 1, wherein the number-average molecular weight of the crystallization inhibitor is from 20 000 to 5 000 000 g/mol.

27. The method of claim 1, wherein the number-average molecular weight of the crystallization inhibitor is from 50 000 to 1 500 000 g/mol.

28. The method of claim 9, wherein the precipitation polymerization reaction occurs in tert butanol.

29. The method of claim 1, wherein the crystallization inhibitor is present from 0.1 to 7% by weight, based on the plant protection formulation.

30. The method of claim 1, wherein the crystallization inhibitor is present from 0.5 to 5% by weight, based on the plant protection formulation.

31. A process for preparing a plant protection formulation comprising the step of adding at least one pesticidal active substance and a crystallization inhibitor to the plant protection formulation, wherein the crystallization inhibitor is prepared by radical copolymerization of
A) acrylamidopropylmethylenesulfonic acid (AMPS) or a salt of AMPS, or a mixture thereof;
B) one or more macromonomer of the formula (1)
R¹—Y—(R²—O)ₓ(R⁴—O)_{z}—R³ (1)
wherein R¹ is an acryloyl or methacryloyl residue;
R² and R⁴ is, independently of one another, C₂-alkylene or C₃-alkylene;
x and z is, independently of one another, an integer between 0 and 50 wherein x+z is greater than or equal to 1;
R³ is a (C₄-C₂₂)-alkyl or a (C₄-C₂₂)-alkenyl residue; and
D) optionally one or more additional at least mono- or polyolefinically unsaturated oxygen-, nitrogen-, sulfur-, phosphorus-, chlorine- and/or fluorine-comprising comonomers.

32. A plant protection formulation made in accordance with the process of claim 31.
